(19) United States
(12) Patent Application Publication
(10) Pub. No.: US 2005/0171813 A1
(43) Pub. Date: Aug. 4, 2005

(54) System for identifying and sorting orders

(76) Inventor: Mchael L. Jordan, Alpharetta, GA (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 10/772,196

(22) Filed: Feb. 4, 2004

(51) Int. Cl. G06F 17/60

(52) U.S. Cl. 705/2; 700/231

(57) ABSTRACT

A method of discriminating between orders is comprised of evaluating a queue of orders based on whether each prescription within each order can be filled in an automated or non-automated manner. A set of workstations for each prescription is then determined based on the evaluating. For those orders that can be filled entirely in an automated manner, the set of workstations for each prescription excludes a pharmacist review workstation. Another aspect of the present disclosure is directed to a method of operating a prescription filling facility of the type having automated equipment and non-automated equipment for filling orders, the improvement comprising identifying an order that can be filled with automated equipment and routing at least one container to be filled for the order in a manner that eliminates a review of the order by a pharmacist. Because of the rules governing abstracts, this abstract should not be relied upon in construing the claims

### BACKGROUND

The present disclosure is related to automated prescription filling apparatus and systems.

Automated prescription filling systems are known in the art as illustrated by U.S. Pat. No. 6,256,967 entitled Integrated Automated Drug Dispenser Method and Apparatus issued Jul. 10, 2001 to Hebron et al. and U.S. Pat. No. RE37,829 entitled Automated Prescription Vial Filling System reissued Sep. 3, 2002 to Charhut et al. In both of these patents, the systems receive instructions for the filling of prescriptions using automated equipment. However, in a typical prescription filling facility, prescriptions will be filled in a variety of ways with a wide variety of medicaments. Not only are there prescriptions to be filled by automated equipment counting the number of pills for the prescription, but there may also be prescriptions to be filled by manually counting the number of pills for the prescription. Manual counting may be necessary because the medicament is slow moving, i.e. not prescribed often, and therefore is not stocked in automated equipment which is typically reserved for often prescribed medicaments. The medicament may be of a unique size or shape, or may be very fragile, such that the medicament is not well suited to be dispensed with automated equipment. As a result, there may be substantial numbers of medications that cannot be filled by automated equipment during any given shift. The 80/20 rule is very prevalent in this process. That is, 80% of the volume is made up by 20% of the medications or, stated in another way, 80% of the medications make up 20% of the volume.

Modem prescription filling lines take into account this need for flexibility in filling prescriptions. A modem prescription filling line, like the puck based system with PLUS modules available from McKesson Automation Systems, has a conveyor that moves labeled vials among a variety of workstations. One workstation may include a bank of Baker cells from which medications are automatically counted and dispensed into a labeled vial. Another workstation may include a plurality of Baker cassettes and a counting device. The cassette having the correct medicament is moved from its storage location, either by a person or a robot, to the counter where the proper amount of medicament is counted and dispensed into a labeled vial. Technologies other than Baker cassettes, such as AccuMed cells or AccuScript robots, may be used instead. Another workstation may include a completely manual workstation where pills are manually counted, unit dose medicaments are counted, etc. for the manual filling of the prescription. From these workstations, the filled vials are moved by the conveyor to various checking stations that may include a scale, camera, as well as a pharmacist station for visual examination of the filled vial. A capping station may also be provided followed by sorting and packing stations.

Although modem prescription filling lines provide the needed flexibility to enable prescriptions to be filled no matter what the source of the medicament to be dispensed, such systems are expensive. It is therefore desirable to increase the throughput of the system whenever possible. Also, different rules may govern depending upon how a prescription is filled. An order, which may be comprised of one or more prescriptions, filled entirely by automated equipment may not require a pharmacist review. Thus, a need exists to enable modern prescription filling lines to discriminate between various types of orders to enable the line to fill the orders in the most efficient manner.

### BRIEF SUMMARY

One aspect of the present disclosure is directed to a method of discriminating between orders comprising evaluating a queue of orders based on whether each prescription within the order can be filled in an automated or non-automated manner, where non-automated is meant to include semi-automated as well as manual. A set of workstations for each prescription is then determined based on the evaluating. For those orders that can be filled entirely in an automated manner, the set of workstations excludes a pharmacist review workstation.

Another aspect of the present disclosure is directed to a method of operating a prescription filling facility of the type having automated equipment and non-automated equipment for filling orders comprised of one or more prescriptions, the improvement comprising identifying an order that can be filled with automated equipment and routing a container to be filled with at least one prescription for the order in a manner that does not require a review of the order by a pharmacist.

Another aspect of the present disclosure is directed to a method of operating a prescription filling line of the type having automated equipment and non-automated equipment for filling orders comprised of one or more prescriptions. The method is comprised of: evaluating a queue of orders based on whether each prescription within each order can be filled in an automated or non-automated manner; selecting an appropriate sized vial, bottle or other end user container; printing and applying a label to the vial; inserting the labeled vial into a carrier; routing the carrier to a prescription filling station; and routing the carrier to an imaging workstation. Where the order has been filled by automated equipment, each carrier for the order is routed to a capper and to a packing workstation without a review by a pharmacist, and where the order has been filled by non-automated equipment, each carrier for the order is routed to a pharmacist workstation before routing the carrier to the capper and packing workstation.

### BRIEF DESCRIPTION OF THE DRAWINGS

For the present invention to be easily understood and readily practiced, the present invention will now be described, for purposes of illustration and not limitation, in conjunction with the following figures, wherein:

FIG. 1 is an illustration of a prescription filling line with which the present invention may be employed;

FIG. 2A illustrates a puck and FIG. 2B illustrates a container that may be used with the prescription filling line of FIG. 1;

FIG. 3 is a flow chart illustrating a method according to one aspect of the present invention; and

FIG. 4 is an illustration of another prescription filling line.

### DETAILED DESCRIPTION

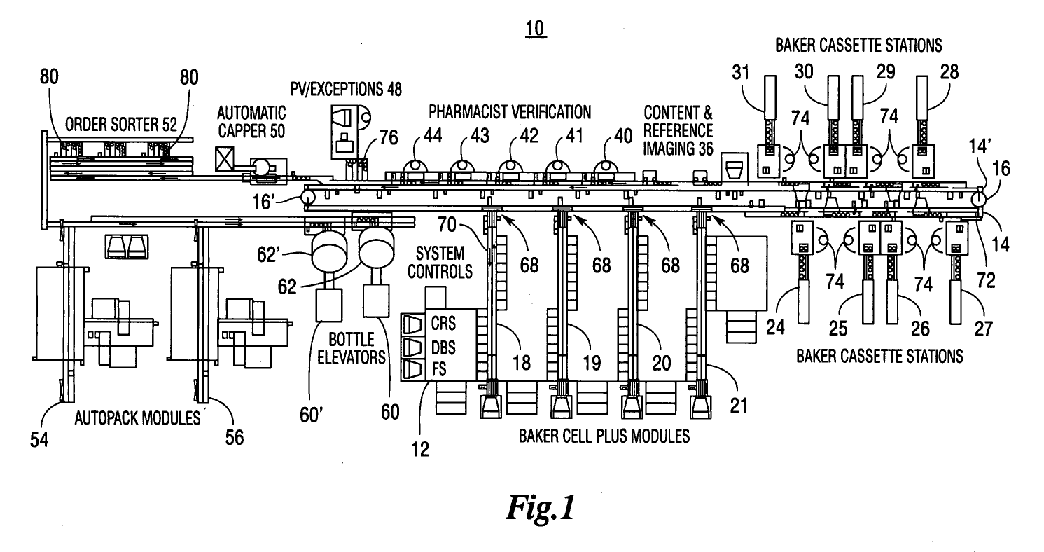

Many prescriptions are no longer filled at retail or institutional pharmacies; prescriptions are often filled at central fill facilities or mail order facilities. Central fill facilities typically receive orders comprised of one or more prescriptions from pharmacies in the surrounding area, fill the orders, and return the filled orders to the pharmacy that originally placed the orders using some logistic/delivery method. A mail order facility will receive orders comprised of one or more prescriptions from individuals, or families, which are filled and mailed to the individual or family placing the order. Central fill, mail order or other types of prescription filling facilities, while they may vary as to how the prescriptions are received (input) and how the filled prescriptions are shipped (output), share a substantial amount of common equipment and workflow between the input and output. One example of a central fill facility is illustrated in FIG. 1. The reader should recognize that although the present invention is discussed in the context of the central fill facility of FIG. 1, the invention is equally applicable to mail order facilities, or any other facilities employing both automated and manual techniques for the filling of orders comprised of one or more prescriptions.

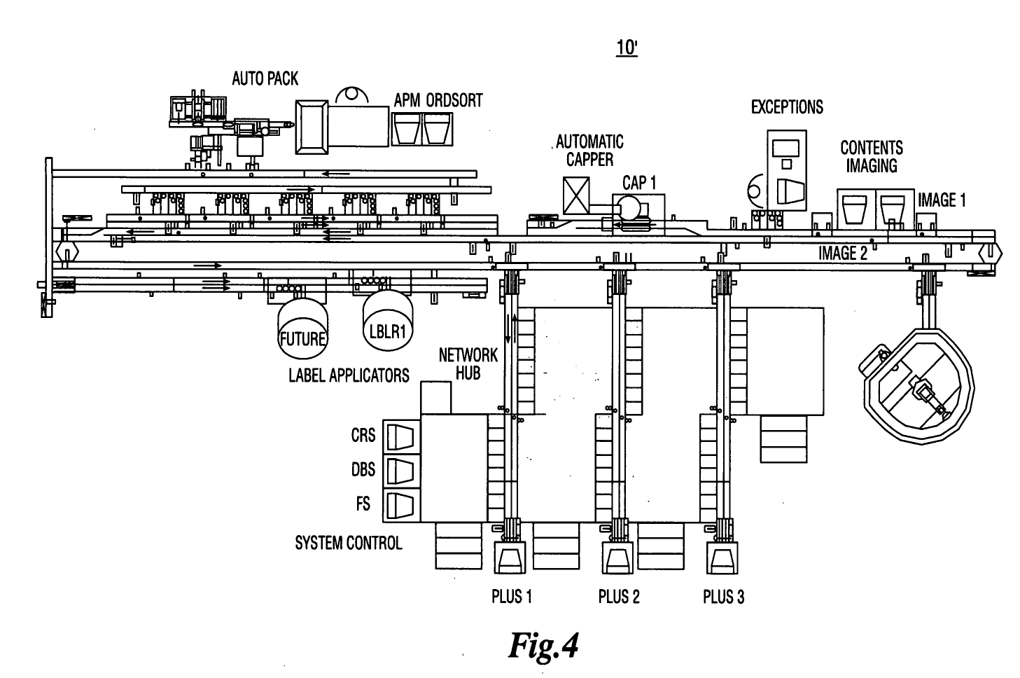

In FIG. 1, a prescription filling line 10 is illustrated. The line 10, and the various workstations clustered around the line 10, are under the control of system control 12, which is typically a computer. A first transport belt 14 connected to a second transport belt 14′ by transfer tables 16, 16′ provides a mechanism for transporting items among the various workstations. A plurality of workstations are clustered around the transport belt 14, 14′ and may include, for example, Baker Cell Plus workstations 18-21, Baker cassette workstations 24-31, content and reference imaging workstation 36, pharmacist verification workstations 40-44, exception workstation 48, capping workstation 50, order sorting workstation 52 and packing workstations 54, 56. Those of ordinary skill in the art will recognize that the types and numbers of workstations provided will vary depending upon the anticipated throughput of the line 10. For example, a greater or lesser number of Baker Cell Plus workstations 18-21 may be provided. The Baker cassette workstations could be fully automated with a robot moving the Baker cassettes between their storage location and a counter as well as moving the vial to be filled to and from the counter, as is known in the art. Additionally, a greater or lesser number of Baker cassette workstations could be provided. Other technologies such as the AccuMed cells or AccuScript robots may be used in place of the Baker cassettes. A fully-manual workstation (not shown) may be provided for items not stocked in either the Baker cells or Baker cassette workstations, or for items such as tubes of ointment, unit dose packaged items, or any other item which requires manual selection and dispensing. The content and reference imaging workstation 36 may include a scale, or the scale may be included in a separate workstation. Near infrared (NIR) imaging may also be employed in workstation 36, with a weighing workstation (not shown) or as a separate workstation. Other types of workstations used to validate or otherwise check the prescription(s) making up an order may be provided. Thus, the illustration of the various workstations in FIG. 1 should be understood as being exemplary and not in any way limiting upon the present invention. For example, and as is described in greater detail below, the embodiment of FIG. 1 illustrates how the present invention may be employed in a line having automated and non-automated equipment. Another embodiment is described in conjunction with FIG. 4 in which the present invention is employed in a dedicated line.

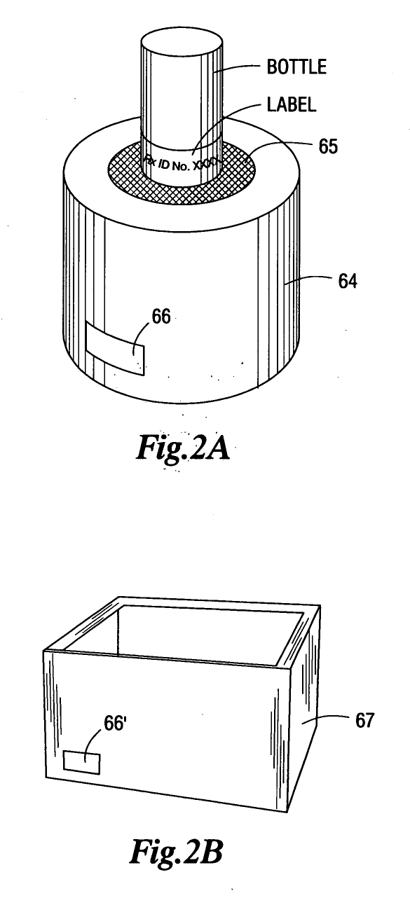

Continuing with the description of FIG. 1, the transport belt 14 has associated therewith two elevators 60, 60′ which feed bottles, vials or other appropriate end user containers to labelers 62, 62′, respectively. The elevators 60, 60′ are merely one example of a source of containers, e.g. bottles or vials, which may be filled with a prescription for a patient. The bottle, vial, or other container is labeled by the labelers 62, 62′ and inserted in to a puck 64 (shown in FIG. 2A). The bottles or vials may be of the same diameter but of differing heights so as to provide differing capacities. Alternatively, the puck 64 may carry an insert 65 so that bottles or vials of varying diameter may be accommodated to provide bottles or vials of differing capacities. The line 10 may also carry square or rectangular containers 67 seen in FIG. 2B for ointments, blister packs, unit-of-use items or other items that will not fit within a vial or bottle. In that manner, line 10 may carry all types of carriers (both pucks 64 and containers 67) needed to fill an order within the same line 10.

The puck 64 or container 67 may carry a radio frequency identification tag 66, 66′, respectively, or other type of identifier. In one embodiment, the tag 66, 66′ is passive. The prescription being filled is associated with the RFID 66, 66′ (or other identifier) by the control computer 12. In that manner, a labeled bottle or vial being carried by a puck 64 is associated with the prescription being filled. Any sensor within line 10 that is capable of reading the identifier, such as a radio frequency sensor for reading the puck's 64 or container's 67 RFID can, by virtue of the association in computer 12, receive information about the prescription which that bottle or container, respectively, is to contain, e.g. the prescribed drug, drug strength, drug style (pill, gelcap, etc.) number prescribed, etc.

The manner in which pucks 64 carrying vials or bottles are handled by the various workstations will now be described. The reader should note, however, that this information is being provided for purposes of completeness and is not intended to limit the present invention. Also, the following description is equally applicable to containers 67. Any manner of interfacing the workstations with the transport belt 14, 14′ may be used. Beginning with the Baker Cell Plus workstations 18-21, each of the workstations has associated therewith sensors, a gate, and a pneumatic piston generally designated by reference number 68. A sensor, e.g. an RF reader, associated with equipment 68 reads the RFID tag 66 on each puck 64 as it approaches and, should the drug to be dispensed be in Baker Cell Plus workstation 18, a door or gate blocks belt 14. When the puck carrying the bottle of interest is restrained by the gate, a pneumatic piston or other device pushes the puck off of belt 14 onto a secondary belt 70. The secondary belt 70 carries the puck 64 to the proper location within the Baker Cell Plus workstation 18 so that the pills may be dispensed. Thereafter, the puck 64 is returned to transport belt 14. The other Baker Cell Plus workstations 19-21 are similarly constructed and work in the same manner.

Each of the Baker cassette workstations 24-27 has similar equipment 68 for diverting a puck 64 to a secondary belt 72. The secondary belt 72 has a plurality of restrictions thereacross, one for each workstation, so that pucks for that workstation are restrained by the restriction. A worker 74 then selects a puck and transports the vial or bottle therein to a counter. The worker 74 also transports a Baker cassette to the counter where the appropriate number of the proper prescription is dispensed. Thereafter, the cassette is returned to its storage location, the vial or bottle returned to the puck, and the puck returned to transport belt 14. The Baker cassette workstations 28-31 operate in a similar manner. However, the function of the secondary belt 72 may be provided by simply providing appropriate partitions above transport belt 14′.

The content and reference imaging workstation 36 as well as the pharmacist verification workstations 40-44 may have a similar arrangement of equipment 68 and a secondary belt as has been described in conjunction with Baker cassette workstations 28-31 and the secondary belt 72. The exception workstation 48 typically has a plurality of lanes into which prescriptions having some discrepancy which must be reconciled are queued. A puck 64 carrying a vial or bottle in which the prescription has been filled and checked, if necessary, is directed to the automatic capping workstation 50 and from there to the order sorting workstation 52. The order sorting workstation 52 typically has a plurality of lanes 80 which may be used to collect multiple prescriptions required for a single order. When an order is complete, it may be released from the order sorting workstation 52 to one of the packaging workstations 54, 56. After the bottles or vials have been removed from the pucks 64 at the packaging workstations 54, 56, the pucks are returned to labelers 62, 62′ so as to be used again. If, at capping workstation 50, the prescription is not complete, the transfer table 16′ can be used to return the bottle to the belt 14 and the beginning of the workstations, while bypassing labelers 60, 62′ as shown in FIG. 1. The reader is again reminded that the number and composition of workstations, method of transporting containers to be filled amongst the workstations and whether the line 10 is circular or linear are all matters of design choice determined by the expected throughput of the facility and are therefore not limiting on the scope of the present invention.

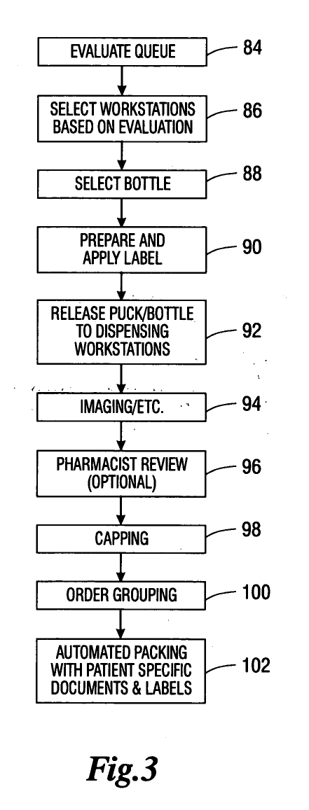

Turning to FIG. 3, the process begins at 84 with a software routine that evaluates a queue of orders and selects an order in which all of the order's components (i.e., prescriptions) can be completely filled by a subset of the customer's dispense profile, e.g. can the prescription be filled in an automated manner, non-automated manner, etc. “Customer” in this instance is the owner or operator of the line 10. At 86 a set of workstations is then selected based on the evaluation. The set of workstations will be a subset of the workstations shown in FIG. 1, or the desired set of workstations might be configured as a separate line if sufficient throughput justifies grouping that desired set of workstations as a separate line. See FIG. 4. for an example of a subset of workstations from FIG. 1 organized into a separate prescription filling line 10′. The software routine preferably determines if all of the prescriptions comprising one order meet the same subset of the customer's dispense profile and, if so, the order will be released to the line 10 of FIG. 1 or the line 10′ of FIG. 4 for processing. The medications that are fillable in a completely automated manner are selected by the customer and are generally the top 500 oral solid dosage forms that can be automatically dispensed.

Once an order comprising one or more prescriptions has been evaluated and the set of workstations determined, the order is released for further processing including automatically selecting at 88 an appropriately sized bottle or vial, formatting, printing and applying a patient specific label 90, and routing the vial/bottle by means of a puck or other carrier to the appropriate automated dispensing equipment (Baker Cell Plus workstations 18-21, Baker Cassette workstations having robots, AccuScript Robots, AccuMed Stations, etc.). After the dispensing process at 92, an image of the contents may be taken and stored at 94 and the vial or bottle automatically capped at 98, skipping review by the pharmacist at 96 in those jurisdictions in which a pharmacist review is not required for orders/prescriptions filled by automated equipment.

If multiple prescriptions and/or pucks are involved in the order fulfillment process, then the system will track all of the associated carriers and will direct them at 100 to one of the lanes 80 within the order grouping workstation 52. When all of the prescriptions within an order have been gathered, the bottle(s) are released at 102 to one of the automated packing stations 54, 56. The automated packing process preferably groups all of the components of the order, prints patient specific documents, stuffs a bag/envelope with these documents and all of the associated bottles/vials, and applies a shipping label to the outside of the bag at 102.

Applying this method in the context of the line 10 of FIG. 1, the selection of workstations results in some subset of the available workstations being selected. Should it be determined that all of the prescriptions within an order can be filled in a completely automated manner, then the order may be filled without the need for a pharmacist's review in some jurisdictions. If any part of the order is filled in a non-automated manner, then the entire order may need to be reviewed by a pharmacist. In the context of FIG. 4, should it be determined that all of the prescriptions within an order can be filled in a completely automated manner, then the order may be directed to the line 10′. If any part of the order needs to be filled in a non-automated manner, which is not available on line 10′, then those prescriptions that can be filled on line 10′ may still be filled on line 10′. However, after filling they may be placed on line 10 so that they may be reviewed by a pharmacist, as needed, and grouped with the remainder of the order.

While the present invention has been described in connection with preferred embodiments thereof, those of ordinary skill in the art will recognize that many modifications and variations are possible. The present invention is intended to be limited only by the following claims and not by the foregoing description which is intended to set forth the presently preferred embodiment.

1. A method of discriminating between orders, comprising:
evaluating a queue of orders based on whether each prescription within the order can be filled in an automated manner; and
determining a set of workstations for each prescription based on said evaluating.

2. The method of claim 1 wherein for orders that can be filled entirely in an automated manner, said determining a set of workstations excludes a pharmacist review workstation.

3. The method of claim 1 additionally comprising selecting an appropriate sized end user container, printing and applying a label to said container, inserting the labeled container into a carrier, and routing the carrier among the determined set of workstations.

4. The method of claim 3 wherein said routing includes routing the carrier from a dispensing workstation, to an imaging workstation, and to a capping workstation.

5. The method of claim 4 additionally comprising tracking multiple prescriptions that belong to one order and grouping all the prescriptions that belong to one order for shipping.

6. The method of claim 4 additionally comprising routing the carrier to a packing workstation where a patient specific document is printed and inserted into a labeled bag along with the patient's prescription.

7. A method of operating a prescription filling facility of the type having automated equipment and non-automated equipment for filling prescriptions, the improvement comprising identifying an order that can be filled with automated equipment and routing at least one container to be filled for said order in a manner that eliminates a review of the order by a pharmacist.

8. The method of claim 7 additionally comprising determining a set of workstations for each prescription comprising said order identified as being fillable with automated equipment.

9. A method of operating a prescription filling line of the type having automated equipment and non-automated equipment for filling prescriptions, comprising:
evaluating a queue of orders based on whether each prescription within each order can be filled in an automated manner;
selecting an appropriate sized end user container;
printing and applying a label to said container;
inserting the labeled container into a carrier;
routing the carrier to a prescription filling station;
routing the carrier to an imaging workstation; and
where said order has been filled by automated equipment, routing each carrier for said order to a packing workstation without a review by a pharmacist, and where said order has at least one prescription filled by non-automated equipment, routing each carrier for said order to a pharmacist workstation before routing each carrier to the packing workstation.
